(19) United States
(12) Patent Application Publication
(10) Pub. No.: US 2020/0228150 A1
(43) Pub. Date: Jul. 16, 2020

(54) APPARATUS TO ADD CONTROL SIGNALS THROUGH RF SIGNAL

(71) Applicant: QUALCOMM Incorporated, San Diego, CA (US)

(72) Inventor: Magnus Olov WIKLUND, San Jose, CA (US)

(21) Appl. No.: 16/246,230

(22) Filed: Jan. 11, 2019

(51) Int. Cl. H04B 1/04

(52) U.S. Cl. CPC H04B 1/04

(57) ABSTRACT

The apparatus for wireless communication receives, from a power amplifier of a second module of a second apparatus, a signal including a RF signal for transmission by a first module of a first apparatus and a control signal modulated with the RF signal. The apparatus for wireless communication filters the control signal from the RF signal within the received signal. The apparatus for wireless communication modifies at least one component within the apparatus based on the filtered control signal. The apparatus for wireless communication transmits the RF signal, the transmission of the RF signal being based on the at least one component modified based on the received control signal.

### BACKGROUND

### Field

The present disclosure relates generally to communication systems, and more particularly, to an apparatus to add control signals through RF signals.

### Background

Wireless communication systems are widely deployed to provide various types of communication content such as, for example, voice, data, and so on. Typical wireless communication systems may be multiple-access systems capable of supporting communication with multiple users by sharing available system resources. Generally, wireless multiple-access communication systems may simultaneously support communication for multiple mobile devices. Each mobile device may communicate with one or more access points (e.g., base stations, femtocells, picocells, relay nodes, and/or the like) via transmissions on forward and reverse links. The forward link (or downlink) refers to the communication link from access points to mobile devices, and the reverse link (or uplink) refers to the communication link from mobile devices to access points.

Communications between mobile devices and access points may be established via single-input single-output (SISO) systems, multiple-input single-output (MISO) systems, multiple-input multiple-output (MIMO) systems, and so forth. In addition, mobile devices can communicate with other mobile devices (and/or access points with other access points) in peer-to-peer wireless network configurations, such as in a wireless personal area network (WPAN).

A WPAN is a personal, short-range wireless network for interconnecting devices centered around a specific distance from a user. WPANs have gained popularity because of the flexibility and convenience in connectivity that WPANs provide. WPANs, such as those based on short-range communication protocols (e.g., a Bluetooth® (BT) protocol, a Bluetooth® Low Energy (BLE) protocol, a Zigbee® protocol, etc.), provide wireless connectivity to peripheral devices by providing wireless links that allow connectivity within a specific distance (e.g., 5 meters, 10 meter, 20 meters, 100 meters, etc.).

BT is a short-range wireless communication protocol that supports a WPAN between a central device (e.g., a master device) and at least one peripheral device (e.g., a slave device). Power consumption associated with BT communications may render BT impractical in certain applications, such as applications in which an infrequent transfer of data occurs. Controlled passive elements may be used in a variety of wireless communication systems, such as but not limited to WPANs and MIMO systems. However, adding controlled passive elements in some systems (e.g., matching networks and/or MIMO antenna systems) may be challenging. Control signals for such passive elements need to be wired from a controlling chip to each of the controlled passive elements. Adding control lines for each passive elements can be difficult because it requires respective pins for each respective passive element to be allocated on the controlling chip, and the controlling chip is usually limited in the amount of pins.

There exists a need for a controlling technique to reduce the number of control pins required in the controlling chip for controlled passive elements, such that the number of controlled passive elements that may be added is independent on the available control pins on the controlling chip.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Controlled passive elements may be used in a variety of wireless communication systems, such as but not limited to WPANs and MIMO systems. However, adding controlled passive elements in some systems (e.g., matching networks and/or MIMO antenna systems) may be challenging. Control signals for such passive elements need to be wired from a controlling chip to each of the controlled passive elements. The control signals are provided from the chip to each of the controlled passive elements using separate control lines for each of the controlled passive elements. Adding control lines for each passive elements can be difficult because it requires respective pins for each respective passive element to be allocated on the controlling chip, and the controlling chip is usually limited in the amount of pins. In some instances, front end modules (FEM) and/or variable capacitor control may require one or more pins, depending on how many states are represented. Control signals are fixed and have to adhere to a specified interface which imposes severe restrictions on hardware changes. As such, the amount of passive elements that may be added may be limited upon the available pins on the controlling chip.

There exists a need for a controlling technique to reduce the number of control pins required in the controlling chip when adding controlled passive elements by utilizing a single wire control with communication protocol, such that the number of controlled passive elements that may be added is independent on the available control pins on the controlling chip.

The controlling techniques of the present disclosure promote a reduction in the number of control pins required in the controlling chip when adding controlled passive elements by receiving a signal including a RF signal for transmission and a control signal modulated with the RF signal, filtering the control signal from the RF signal, modifying at least one component based on the filtered control signal, and transmitting the RF signal, where the transmission of the RF signal being based on the at least one component modified based on the received control signal. The techniques therefore reduce the hardware constraints of the controlling chip when adding passive elements. As such, the number of available controlling pins on the controlling chip does not limit the number of passive elements that may be added.

In an aspect of the disclosure, a method, a computer-readable medium, and an apparatus are provided. The apparatus may receive, from a power amplifier of a second module of a second apparatus, a signal including a radio frequency (RF) signal for transmission by a first module of a first apparatus and a control signal modulated with the RF signal. The apparatus may filter the control signal from the RF signal within the received signal. The apparatus may modify at least one component within the apparatus based on the filtered control signal. The apparatus may transmit the RF signal, the transmission of the RF signal being based on the at least one component modified based on the received control signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating an example of a base station and user equipment (UE) in an access network.

FIG. 3 is a diagram illustrating an example of a prior art configuration.

FIG. 4 is a diagram illustrating a module in accordance with certain aspects of the disclosure.

FIG. 5 is a diagram illustrating a module in a master-slave configuration in accordance with certain aspects of the disclosure.

FIG. 6 is a diagram illustrating wireless communication in accordance with certain aspects of the disclosure.

FIG. 7 is a flowchart of a method of wireless communication.

FIG. 8 is a conceptual data flow diagram illustrating the data flow between different means/components in an exemplary apparatus.

FIG. 9 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

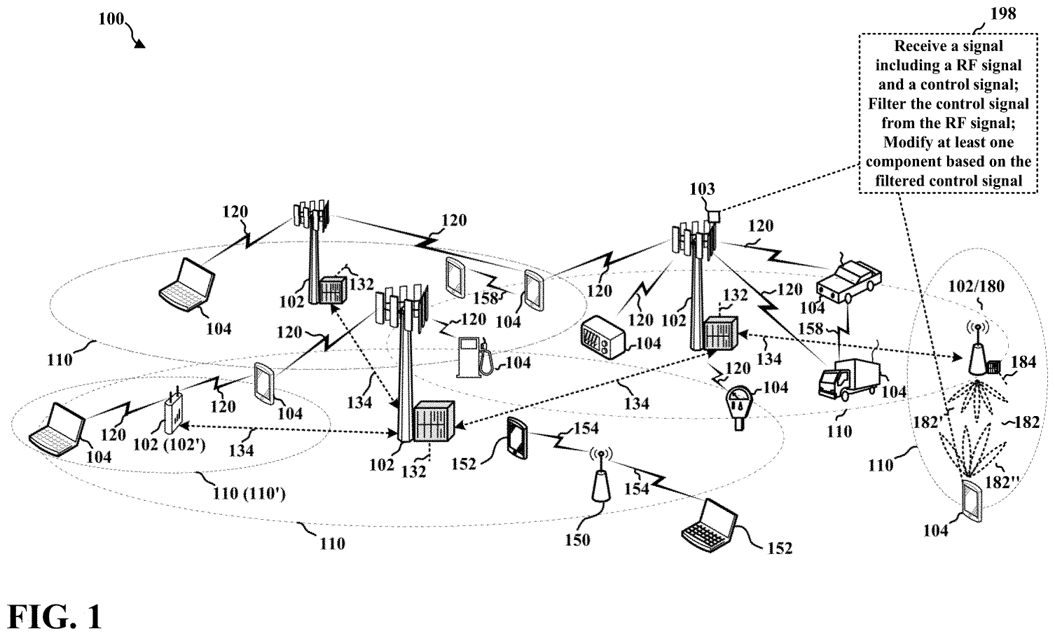

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and a 5G Core (5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, Bluetooth Low Energy, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

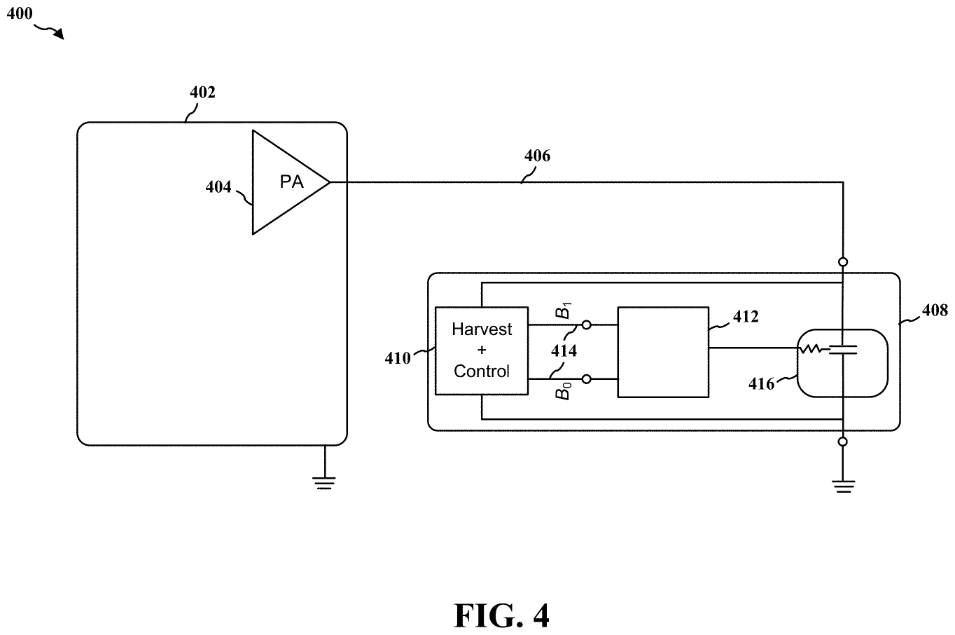

Referring again to FIG. 1, in certain aspects, the base station 102 may comprise a front end module 103, and the front end module 103 may be configured to receive (198) a signal including a RF signal and a control signal modulated with the RF signal. The front end module 103 may be configured to filter the control signal from the RF signal. The front end module 103 may be configured to modify at least one component based on the filtered control signal, e.g., as described below in connection with any of FIGS. 4-9. In some aspects, a UE 104 may be configured to receive (198) a signal including the RF signal and the control signal modulated with the RF signal. The UE 104 may be configured to filter the control signal from the RF signal, and may be configured to modify at least one component based on the filtered control signal.

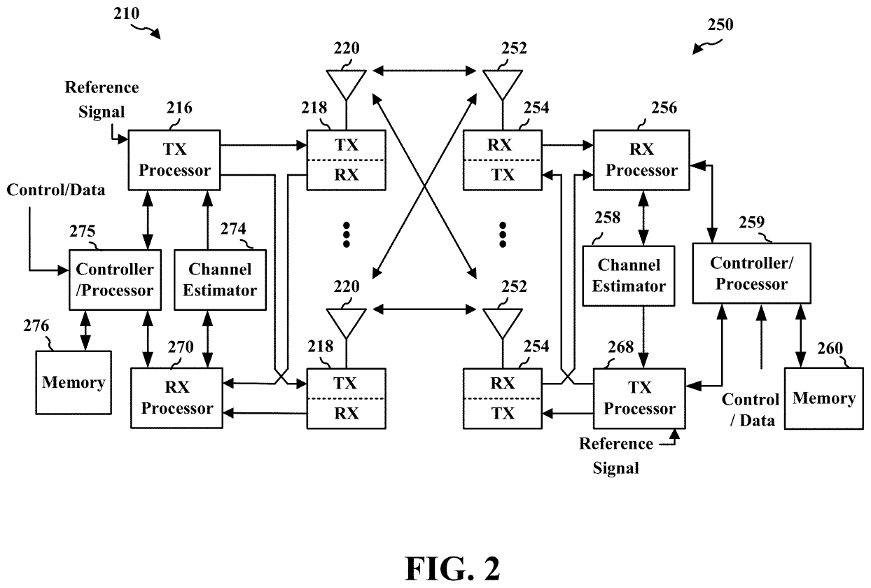

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission.

The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

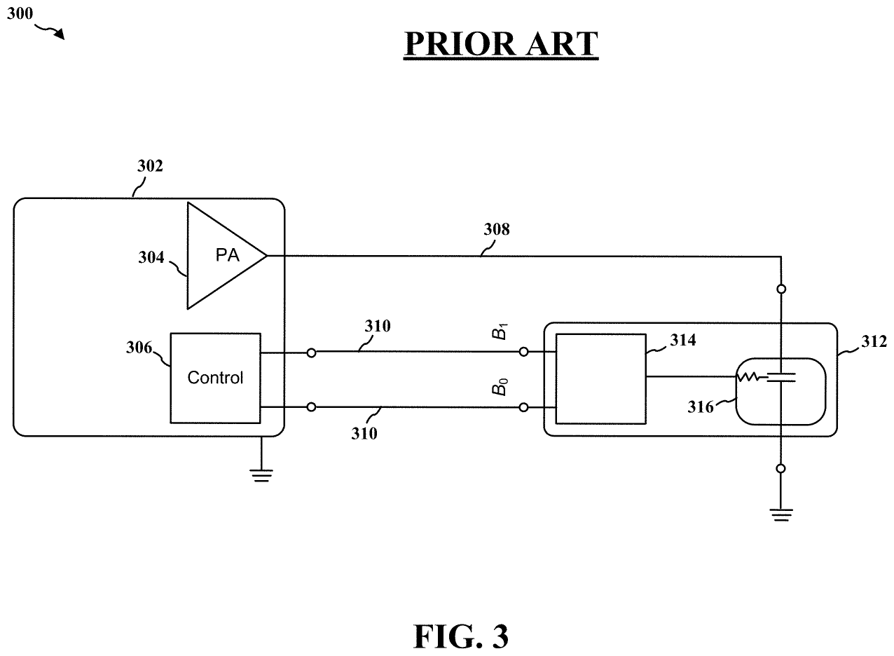

FIG. 3 illustrates a diagram 300 of a conventional wired module 312 connected to a control device 302. The control device 302 may comprise, among other components, a power amplifier 304 and a control chip 306. The wired module 312 comprises a component 314 and a circuit 316. The component 314 includes inputs B₀ and B₁ that are connected to the control chip 306 of control device 302. The inputs B₀ and B₁ are connected to the control chip 306 by control wires 310, respectively. The circuit 316 of wired module 312 may comprise a tunable element (e.g., capacitor) that is controlled or tuned in response to one or more control signal inputs sent by the control chip 306 and received at inputs B₀ and B₁ of the wired module 312. The component 314 receives the control signal inputs from the control chip 306 and performs an operation to tune the circuit 316 in response to the control signal inputs received at B₀ and B₁.

The wired module 312 is also connected to the power amplifier 304 of the control device 302. The power amplifier 304 provides power to the wired module 312 via power line 308, such that the component 314 may perform the one or more operations in response to the one or more control signals sent by the control chip 306.

The configuration of the control device 302 and the wired module 312 is limited with respect to the ability to add additional modules. The limitation may arise from the control chip 306. The control chip 306 has a finite amount of control pins or output pins that may be utilized for wired modules 312. Adding control lines for additional wired modules may be a challenge because this requires control pins to be allocated on the control chip 306 to support the additional wired module. For example, in FIG. 3, the circuit 316 of the wired module 312 may comprise a tunable capacitor (e.g., variable capacitor), which requires at least two control pins from the control chip 306 with a respective control wire 310 connected to each of the control pins and the corresponding input at the component 314, in order for the component 314 to be able to tune the capacitor. The ability to add additional wired modules 312 may be limited by the number of available control pins at the control chip 306 and/or the number of wired control pins required by the additional wired module. Some wired modules (e.g., front end modules, variable capacitors) may require one or more control pins based on the number of states that are represented. In some instances, a wired module may require a plurality of control pins, but may not be added because the control chip 306 does not have the requisite amount of available control pins to account for each of the plurality of requisite control pins needed to add the wired module. In addition, control signals may be fixed and must adhere to a specified interface, which may impose severe restrictions on hardware changes. Lastly, running control wires 310 between each of the control pins of the control chip 306 and the inputs of the component 314, may be burdensome or difficult in instances where the distance between the control device 302 and the wired module 312 is great or inaccessible.

There exists a need for a controlling technique to reduce the number of control pins required on the control chip for controlled passive elements, such that the ability to add controlled passive elements is not constrained by the number of available control pins on the control chip.

The present disclosure provides a controlling technique that reduces the number of control pins required in the control chip when adding controlled passive elements by utilizing a single wire control with communication protocol. The controlling technique may be configured to extract the communication protocol modulated with a signal transmitted on the single wire control, such that adding controlled passive elements is independent of the available control pins on the control chip.

FIG. 4 illustrates a diagram 400 of an apparatus for wireless communication in accordance with certain aspects of the disclosure. In the aspect of FIG. 4, communication may be between the first module 408 and a second module or control module 402 in a WPAN (e.g., Bluetooth network) in accordance with certain aspects of the disclosure. However, in some aspects, the communication may be between the first module 408 and the control module 402 in many different types of networks, and the disclosure is not intended to be limited to a WPAN. For example, the first module 408 and the control module 402 may be in a WWAN, MIMO, SISO, Wi-Fi, or the like. In some aspects, the first module 408 may be a component of a first apparatus (not shown), while the second module 402 may be a component of a second apparatus (not shown). The first apparatus may be on a first printed circuit board (PCB). The second apparatus may be on a second PCB. In some aspects, the first PCB and the second PCB are different. In some aspects, the first PCB and the second PCB are the same PCB. In some aspects, the first apparatus may correspond to, e.g., front end module 103, base station 102, UE 104, AP 150, STA 152, the apparatus 802/802′, or the node 850. The second apparatus may correspond to, e.g., the front end module 103, base station 102, UE 104, AP 150, STA 152, the apparatus 802/802′, or the node 850.

The second module or control module 402 may comprise, among other components, a power source (e.g., power amplifier 404). The power source (e.g., power amplifier 404) of the control module 402 may be configured to provide power to the first module 408. The first module 408 may comprise a first control circuit or chip 410, a first component 412, control wires 414 connecting the first control circuit or chip 410 to the first component 412, and a circuit 416. In some aspects, the first component 412 may be comprised of a memory module, a logic component with drivers for performing an operation (e.g., tuning), and/or a component configured to toggle a state of a control.

The first module 408 may share some similarities with the wired module 312 of FIG. 3. For example, both the wired module 312 and the first module 408 comprise a component 314, 412 and a circuit 316, 416 having a tunable element (e.g., capacitor). However, the first module 408 of FIG. 4 may further comprise the first control chip 410. The first control chip 410 being within the first module 408 may reduce or eliminate the need for control wires extending between the control module 402 and the first module 408. As shown in FIG. 4, the first control chip 410 may be within the first module 408 and may be external to the control module 402, such that the first module 408 is connected to the power amplifier 404 of the control module 402 via power line 406. At least one advantage of the disclosure is that the first module 408 may have one connection with the control module 402, namely power line 406, and does not require control wires to be routed to the first module 408. By placing the first control chip 410 within the first module 408, the first module 408 may be configured to provide all the requisite control pins needed to tune the circuit 416. The ability to connect the first module 408 with the control module 402 may no longer be reliant on a control chip within the control module 402 having the required amount of available control pins.

The power amplifier 404 may be configured to provide a signal which includes a high power RF signal for transmission by the first module 408. The signal from the power amplifier 404 may further comprise a control signal modulated with the RF signal. In some aspects, the control module 402 may include a control signal generator (not shown) that may be configured to generate control signals to be sent to the first module 408. The control module 402 may further include a modulation unit (not shown) that may be configured to modulate the control signals from the control signal generator with the RF signal from the power amplifier 404, such that the control signal may be transmitted to the first module 408 along the power line 406. The modulation unit (not shown) of the first module 408 may be configured to modulate the control signals with the RF signal using many different types of known modulation schemes. For example, the modulation unit may be configured to use an amplitude modulation scheme, a frequency modulation scheme, Near Field Communication (NFC) standard, Time division multiple access (TDMA), direct current, load modulation, low frequency signal, the like, or a combination thereof. In some aspects, control signals may be carried by the RF signal on certain timeslots where there is time reserved for the control signal.

The first module 408 may be configured to receive the signal from the power amplifier 404. The first module 408 may be configured to filter the control signal from the RF signal within the received signal. In some aspects, the RF signal may be transmitted off chip to a personal area network (e.g., Bluetooth, WLAN, User Equipment), where the first module 408 may be configured to harvest energy. The first module may include a filtering circuit (e.g., first control chip 410) that receives the RF signal which filters out the control signal from the RF signal. The control signal is provided to the control circuit (e.g., first control chip 410) within the first module 408. The control circuit (e.g., first control chip 410), within the first module 408, may be configured to modify at least one component (e.g., circuit 416) within the first module 408 based on the filtered control signal. The control circuit (e.g., first control chip 410) sends the control signals to the first component 412 along control lines 414, such that the first component 412 performs an operation in accordance with the control signals to modify the circuit 416. The first module 408 may be configured to transmit the RF signal, such that the transmission of the RF signal may be based on the at least one component modified (e.g., circuit 416) based on the received control signal.

The first module 408 may be further configured to harvest energy from the signal received from the power amplifier 404. In some aspects, the first control chip 410 may comprise a harvesting circuit (e.g., first control chip 410) that may be configured to harvest energy from the received signal from the power amplifier 404. In such aspects, the filtering of the control signal, the modifying of the at least one component (e.g., circuit 416), and/or the transmitting of the RF signal may occur due to the harvested energy. In some aspects, the first module 408 may be configured to harvest energy using load manipulation or RF wireline communication. The disclosure is not intended to be limited to harvesting energy by using load manipulation or RF wireline communication, many other known energy harvesting methods may be used by the first module 408. In some aspects, the first control chip 410 may comprise one or more circuits that may be configured to perform certain functions. For example, the first control chip 410 may comprise a filtering circuit configured to filter out the control signal from the RF signal. The first control chip 410 may comprise a control circuit configured to modify at least one component based on the filtered control signal. The first control chip 410 may further comprise a harvesting circuit configured to harvest energy from the received signal from the power source.

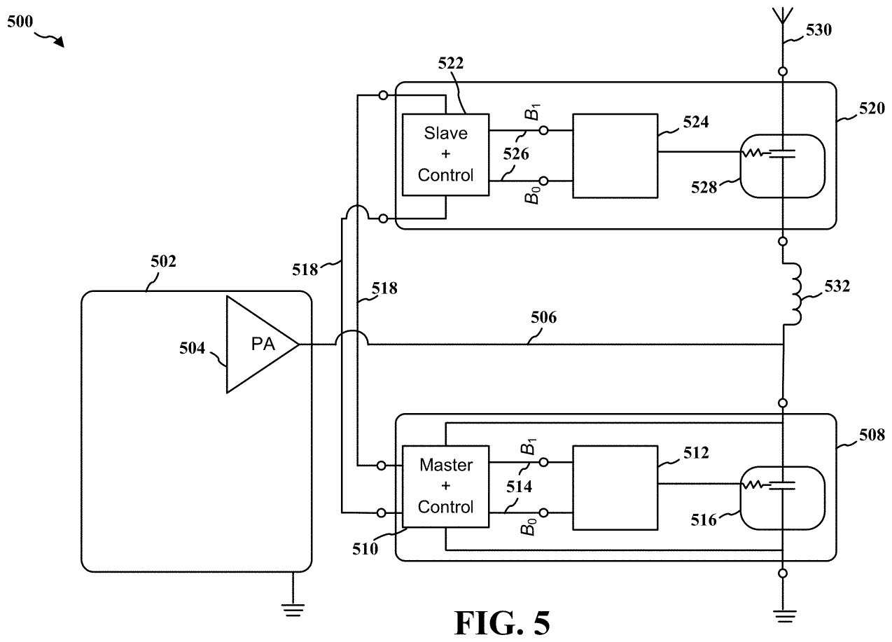

FIG. 5 illustrates a diagram 500 of a first module in a master-slave configuration with a third module in accordance with certain aspects of the disclosure. In the aspect of FIG. 5, communication may be between the first module 508, the second module or control module 502, and/or third module 520 in a WPAN (e.g., Bluetooth network) in accordance with certain aspects of the disclosure. However, in some aspects, the communication may be between the first module 508, control module 502, and/or third module 520 in many different types of networks, and the disclosure is not intended to be limited to a WPAN. For example, the first module 508, the control module 502, and/or the third module 520 may be in a WWAN, MIMO, SISO, Wi-Fi, or the like. In some aspects, the first module 508 may be a component of a first apparatus (not shown), similarly as the first module 408 of FIG. 4, while the second module 502 may be a component of a second apparatus (not shown), similarly as the second module 402 of FIG. 4. The first apparatus may be on a first printed circuit board (PCB). The second apparatus may be on a second PCB. In some aspects, the first PCB and the second PCB are different. In some aspects, the first PCB and the second PCB are the same PCB. In some aspects, the first apparatus may correspond to, e.g., front end module 103, base station 102, UE 104, AP 150, STA 152, the apparatus 802/802′, or the node 850. The second apparatus may correspond to, e.g., the front end module 103, base station 102, UE 104, AP 150, STA 152, the apparatus 802/802′, or the node 850. Third module 520 may be a component of a third apparatus, wherein the third apparatus may be on a third PCB. The third apparatus may correspond to, e.g., front end module 103, base station 102, UE 104, AP 150, STA 152, the apparatus 802/802′, or the node 850.

The first module 508 of FIG. 5 may be configured similarly to the first module 408 of FIG. 4. The second module or control module 502 of FIG. 5 may be configured similarly to the second module or control module 402 of FIG. 4. The third module 520 of FIG. 5 may be configured similarly to the first module 408 and/or first module 508. However, as discussed below, the third module 520 may be in a master-slave configuration with the first module 508, where the first module 508 is a master module and the third module 520 is a slave module.

The diagram 500 comprises the control module 502, the first module 508, and the third module 520. The third module may be connected to the first module 508 in a master-slave configuration. The first module 508 may be connected to the third module 520 via control lines 518. The control lines 518 may be connected to the first control chip 510 of the first module 508 and may be connected to the third control chip 522 of the third module 520. The first control chip 510 of the first module 508 may be configured to send control signals to the third control chip 522 of the third module 520 on the control lines 518, in order to configure the third module 520 as a slave module. The control signals provided by the first control chip 510 to the third control chip 522 may govern the operations that the third module or slave module 520 may perform, such that the third module or slave module 520 may perform the operations as indicated by the control signals from the first control chip 510. The first control chip 510 may be configured in a manner similar to the first control chip 410.

The first module 508 may be configured to harvest energy and filter the signal from the power amplifier 504 to obtain the control signal modulated with the RF signal, in a manner similarly discussed above in connection with the aspect of FIG. 4. However, in the aspect of FIG. 5, only the first module or master module 508 may be connected to the power amplifier 504 of the control module 502 in order to harvest energy and filter the signal from the power amplifier 504 to obtain the control signal modulated with the RF signal. In some aspects, a load 532 may be utilized to isolate the third module 520 from the power amplifier 504, such that the signal sent from the power amplifier 504 on power line 506 may be received by the first module or master module 508. In some aspects, the load 532 may be part of a matching network utilized to connect the first module 508 and the third module 520.

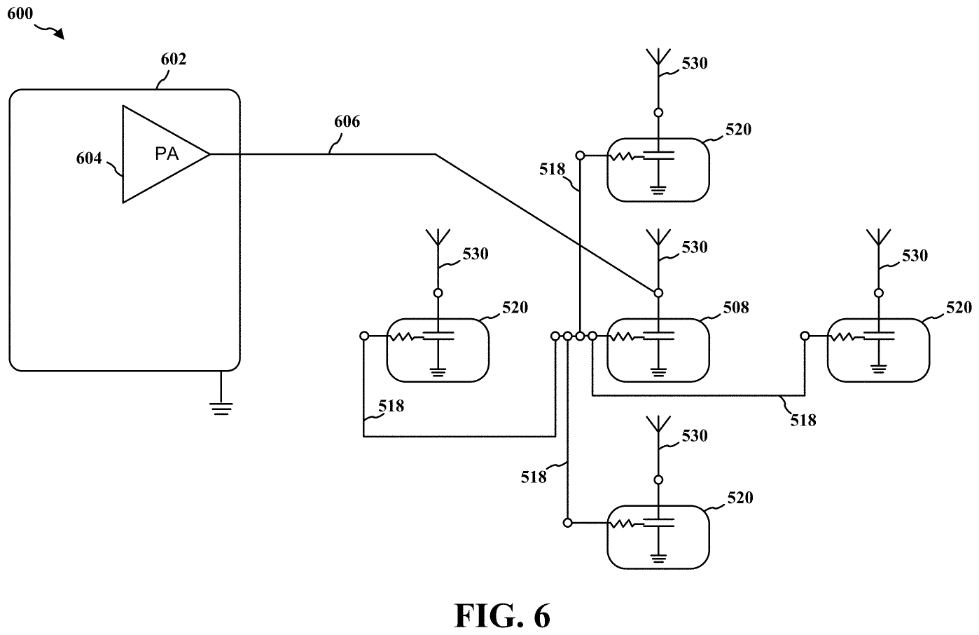

The first module or master module 508 may have control lines 518 connected to the third module or slave module 520, such that the master module 508 may be configured to provide the control signals to the slave module 520 via the control lines 518. The master module 508 may be configured to provide power to the slave module 520. The master module 508 may utilize the harvested energy from the power amplifier 504 to provide power to the slave module 520. The master module 508 may provide power to the slave module 520 via the control lines 518. The slave module 520 may be configured to transmit the RF signal that the master module 508 obtained from the signal from the power amplifier 504. The master module 508, after filtering the received signal from the power amplifier 504 and obtaining the RF signal, may send the RF signal to the slave module 520 via the control lines 518 with instructions to transmit the RF signal. The slave module 520 may transmit the RF signal via an antenna 530 connected to the slave module 520. FIG. 5 discloses an aspect of the disclosure with one slave module 520. However, the disclosure is not intended to be limited to having only one slave module. In some aspects, there can be one or more slave modules 520, as shown, for example, in FIG. 6.

FIG. 6 illustrates a diagram 600 of an apparatus for wireless communication in accordance with certain aspects of the disclosure. The aspect of FIG. 6 comprises the first module 508 in a master-slave configuration with a plurality of third modules 520 in accordance with certain aspects of the disclosure. In the aspect of FIG. 6, communication may be between the first module 508, the second module or control module 602, and/or at least one of the third modules 520 in a WPAN (e.g., Bluetooth network) in accordance with certain aspects of the disclosure. In some aspects, the communication may be between the first module 508, control module 602, and/or at least one of the third modules 520 in many different types of networks, and the disclosure is not intended to be limited to a WPAN. For example, the first module 508, the control module 602, and/or at least one of the third modules 520 may be in a WWAN, MIMO, SISO, Wi-Fi, or the like.

The first module 508 of FIG. 6 may be configured similarly to the first module 508 of FIG. 5 and/or the first module 408 of FIG. 4. The second module 602 of FIG. 6 may be configured similarly to the second module or control module 402, 502 of FIGS. 4 and 5, respectively. The third modules 520 of FIG. 6 may be configured similarly to the third modules 520 of FIG. 5 and/or the first module 408, 508 of FIGS. 4 and 5, respectively. In FIG. 6, the first module 508 and third modules 520 are drawn symbolically in an effort to minimize clutter and to provide a clear depiction of the aspect of FIG. 6. Although the first module 508 and third modules 520 of FIG. 6 do not show all of the components as shown, for example in FIG. 5, the first module 508 and third modules 520 of FIG. 6 still comprise such components and are configured in a similar manner as discussed above in connection with at least the aspects of FIGS. 4 and 5.

In the aspect of FIG. 6, the first module or master module 508 may be configured to be in a master-slave configuration with a plurality of third modules or slave modules 520. The aspects of FIG. 6 discloses a master-slave configuration comprising one master module 508 and four slave modules 520. However, the disclosure is not intended to be limited to the aspects disclosed herein. In some aspects, the master-slave configuration may comprise one or more master modules. In some aspects, the master-slave configuration may comprise two or more slave modules 520.

The master module 508 may receive a signal from a power source (e.g., power amplifier 604) of the control module 602. The power amplifier 604 may send the signal including a control signal modulated with an RF signal to the master module 508 along the power line 606. The master module 508 is the only module that is connected to the control module 602, similarly as in the aspect of FIG. 5. However, in the aspect of FIG. 6, the slave modules 520 do not share a connection with the power line 606, such that the slave modules 520 are physically isolated from the power line 606. The master module 508 may be configured to filter the control signal, as discussed above in connection with the aspects of FIGS. 4 and 5. The master module 508 may be configured to send the control signal to one or more of the slave modules 520. The master module 508 may send the control signal to the slave modules 520 via a respective control line 518. In some aspects, each of the slave modules 520 may be identified by the master module 508 by an identification number or an address, such that that master module 508 may send control signals that are specifically intended for a specific slave module 520.

The master module 508 may also harvest energy as similarly discussed above in connection with the aspects of FIGS. 4 and 5. The master module 508 may harvest energy from the signal sent from the power amplifier 604. The master module 508 may provide power to each of the slave modules 520, such that the slave modules 520 are able to operate due to the harvested energy. The master module 508 may provide power to the slave modules 520 via a respective control line 518. In some aspects, the slave modules 520 may not have a dedicated power source and rely on the harvested energy in order to operate.

The slave modules 520 may each be connected to the master module 508 with a wired connection to receive the control signal from the master module 508, and to receive power. FIG. 6 depicts the control line 518 as a single control line, however, the control line 518 may be comprised of multiple lines or wires and is not intended to be limited to the aspects disclosed herein. The slave modules 520 are not connected to any of the other slave modules 520, and are only connected to the master module 508. The slave modules 520 of FIG. 6 may be configured in a manner similar to the slave module 520 of FIG. 5. However, the slave modules 520 of FIG. 6 may be configured to interact or communicate with one or more of the slave modules 520 via RF coupling. The slave modules 520 of FIG. 6 may be configured to interact or communicate with other slave modules 520 over-the-air using their respective antennas 530.

At least one advantage of the aspect of FIG. 6 is that since none of the master module and/or the slave modules need a connection with a control pin within a control chip of the control module 602, multiple slave modules may be easily added to the master-slave configuration. At least another advantage is that the master module with a plurality of slave modules may be used in a MIMO application. The distribution of power and control signals may be especially attractive in MIMO applications where control routing may be limited to a local area close to an antenna and separate from the feed path from the power source.

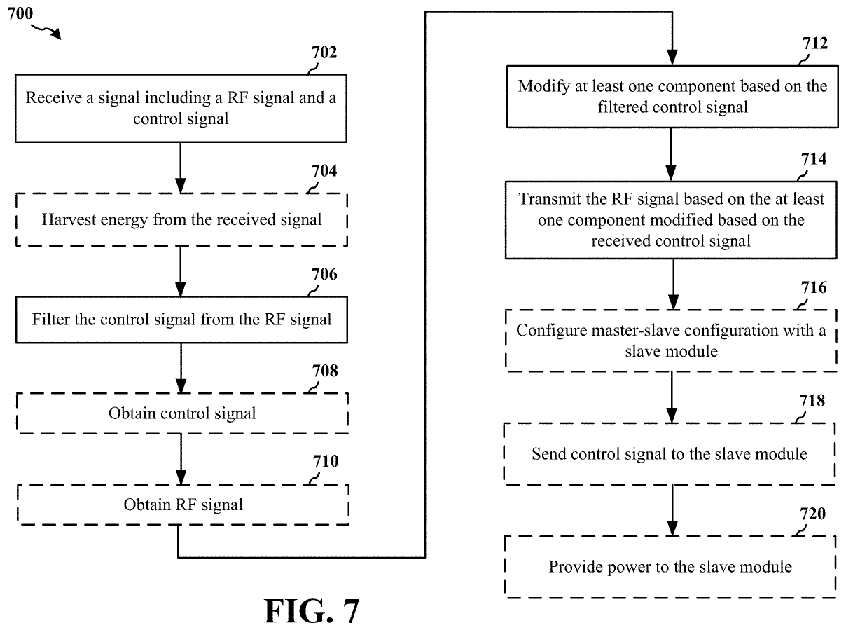

FIG. 7 is a flowchart 700 of a method of wireless communication. The method may be performed by a first module of a first apparatus (e.g., the front end module 103, base station 102, UE 104, AP 150, STA 152, the apparatus 802/802′, or node 850) in communication with a second module of a second apparatus (e.g., the front end module 103, base station 102, UE 104, AP 150, STA 152, the apparatus 802/802′, or node 850). In FIG. 7, optional operations are indicated with dashed lines.

Referring to FIG. 7, at 702, the first module (e.g., module 103, 408, 508) of the first apparatus may be configured to receive a signal including an RF signal for transmission by the first module and a control signal modulated with the RF signal, as discussed in reference to FIGS. 4-6. In some aspects, the first module (e.g., module 103, 408, 508) may receive the signal from a power amplifier (e.g., power amplifier 404, 504, 604) of a second module (e.g., module 402, 502, 602) of the second apparatus. In some aspects, the first apparatus may be on a first PCB and the second aparatus may be on a second PCB. In some aspects, the first PCB and the second PCB are different. In some aspects, the first PCB and the second PCB are a same PCB. At 704, the first module (e.g., module 103, 408, 508) may be configured to harvest energy from the received signal. In some aspects, the first control chip 410 may comprise a harvesting circuit (not shown) that may be configured to harvest energy from the received signal. At 706, the first module (e.g., module 103, 408, 508) may be configured to filter the control signal from the RF signal within the received signal. In some aspects, the first module (e.g., module 103, 408, 508) may comprise a filter circuit (e.g., first control chip 410, 510) configured to receive the RF signal and filter the control signal from the RF signal. At 708, the first module (e.g., module 103, 408, 508) may obtain the control signal after the filter circuit (e.g., first control chip 410) filters out or extracts the control signal from the received signal. At 710, the first module (e.g., module 103, 408, 508) may obtain the RF signal after the filter circuit (e.g., first control chip 410) filters out the control signal.

At 712, the first module (e.g., module 103, 408, 508) may be configured to modify at least one component (e.g., component 416, 516) within the first module based on the filtered control signal. In some aspects, the first module (e.g., module 103, 408, 508) may comprise a control circuit (e.g., first control chip 410, 510) configured to receive the control signal. In some aspects, the control circuit (e.g., first control chip 410, 510) may be configured to modify the at least one component (e.g., component 416, 516) based on the control signal. At 714, the first module (e.g., module 103, 408, 508) may be configured to transmit the RF signal. In some aspects, the transmission of the RF signal may be based on the at least one component (e.g., component 416, 516) modified based on the received control signal. In some aspects, the RF signal may be transmitted by an antenna (not shown) within the first module (e.g., module 408). In some aspects, the RF signal may be transmitted by an antenna 530 connected to the third module (e.g., slave module 520).

At 716, the first module (e.g., module 103, 408, 508) may be configured to configure a master-slave configuration with at least one third module (e.g., module 520) connected to the first module. In some aspects, the first module may be a master module (e.g., module 508) and the at least one third module may be a slave module (e.g., module 520). In some aspects, the at least one third module (e.g., module 520) may be configured to transmit the RF signal. In some aspects, the at least one third module (e.g., module 520) may comprise a plurality of third modules. In some aspects, each of the at least one third modules may be configured to communicate with any of the at least one third modules. At 718, the master module (e.g., module 508) may be configured to send the control signal to the slave module (e.g., module 520). At 720, the first module or master module (e.g., module 508) may be configured to provide power to the at least one slave module (e.g., module 520). The first module or master module (e.g., module 508) may provide power to the at least one slave module (e.g., module 520) via the power lines 518.

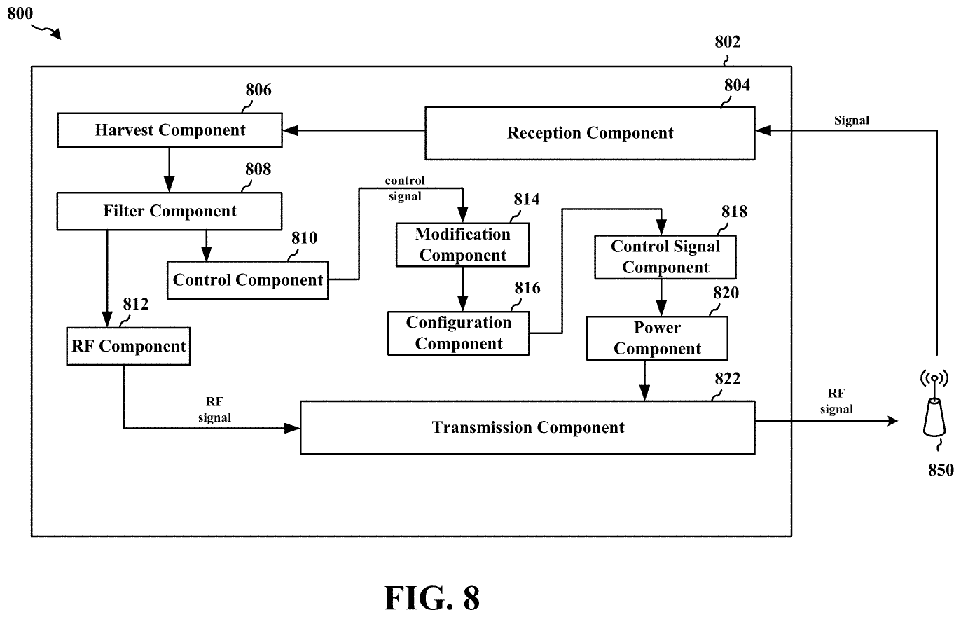

FIG. 8 is a conceptual data flow diagram 800 illustrating the data flow between different means/components in an exemplary apparatus 802. The apparatus may be a first module (e.g., the front end module 103, control module 402, 502, 602, module 408, 508) of a first apparatus (e.g., base station 102, UE 104, AP 150, STA 152, the apparatus 802/802′, or node 850) in communication with a second module (e.g., the front end module 103, control module 402, 502, 602, module 408, 508) of a second apparatus (e.g., base station 102, UE 104, AP 150, STA 152, the apparatus 802/802′, or node 850). The apparatus 802 includes a reception component 804, a harvest component 806, a filter component 808, a control component 810, an RF component 812, a modification component 814, a configuration component 816, a control signal component 818, a power component 820, and a transmission component 822.

The reception component 804 may be configured to receive a signal from the second module (e.g., the front end module 103, control module 402, 502, 602, module 408, 508) including an RF signal for transmission by the first module (e.g., the front end module 103, control module 402, 502, 602, module 408, 508) and a control signal modulated with the RF signal, as discussed in reference to FIGS. 4-6. In some aspects, the reception component 804 may receive the signal from a power amplifier (e.g., 404, 504, 604) of a second device (e.g., the front end module 103, control module 402, 502, 602, module 408, 508, base station 102, UE 104, AP 150, STA 152, the apparatus 802′).

The harvest component 806 may be configured to harvest energy from the received signal. In some aspects, the first module (e.g., module 408, 508) may be configured to perform one or more operations, due to the harvesting component 806 harvesting energy from the received signal. In some aspects, the first module may be a passive device and only receives power due to the harvesting component 806 harvesting energy from the received signal. The filter component 808 may be configured to filter the control signal from the RF signal within the received signal. The control component 810 may be configured to receive a first output signal from the filter component 808, in order to obtain the control signal. The RF component 812 may be configured to receive a second output signal from the filter component 808, in order to obtain the RF signal.

The modification component 814 may be configured to receive the control signal from the control component 810. The modification component 814 may be configured to modify at least one component (e.g., component 416, 516) within the first module or apparatus (e.g., the front end module 103, control module 402, 502, 602, module 408, 508, base station 102, UE 104, AP 150, STA 152, the apparatus 802′) based on the filtered control signal. The configuration component 816 may be configured to configure a master-slave configuration with at least one third module (e.g., module 520) connected to the first module or apparatus (e.g., the front end module 103, control module 402, 502, 602, module 408, 508, base station 102, UE 104, AP 150, STA 152, the apparatus 802′). The configuration component 816 may configure the first module to be a master module (e.g., module 508) and may configure the at least one third module to be a slave module (e.g., module 520). The control signal component 818 may be configured to send the control signal to the slave module (e.g., module 520). The power component 820 may be configured to provide power to the slave module (e.g., module 520). The power component 820 may receive harvested power from the harvest component 806, such that the power component 820 may provide power to the slave module. The transmission component 822 may be configured to receive the RF signal from the RF component 812. The transmission component 822 may be configured to transmit the RF signal from the first module (e.g., the front end module 103, module 408, 508, base station 102, UE 104, AP 150, STA 152, the apparatus 802′). The transmission component 822 may be configured to receive the control signal from the control signal component 818, such that the transmission component 822 may send the control signal to the slave module (e.g., module 520).

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

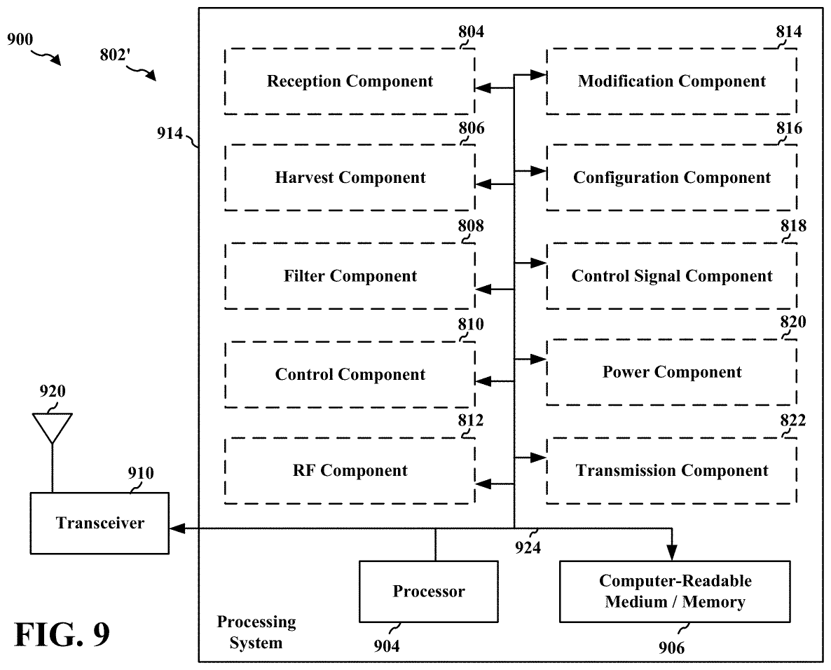

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, 814, 816, 818, 820, 822, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 822, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812, 814, 816, 818, 820, and 822. The components may be software components running in the processor 904, resident/stored in the computer readable medium/memory 906, one or more hardware components coupled to the processor 904, or some combination thereof. The processing system 914 may be a component of the base station 210 and may include the memory 276 and/or at least one of the TX processor 216, the RX processor 270, and the controller/processor 275.

In certain configurations, the apparatus 802/802′ for wireless communication may include means for receiving, from a power amplifier of a second module on a second PCB, a signal including a RF signal for transmission by a first module on a first PCB and a control signal modulated with the RF signal. The apparatus 802/802′ may include means for filtering the control signal from the RF signal within the received signal. The apparatus 802/802′ may include means for modifying at least one component within the first module based on the filtered control signal. The apparatus 802/802′ may include means for transmitting the RF signal from the first module. The transmission of the RF signal may be based on the at least one component modified based on the received control signal. The apparatus 802/802′ may further include means for harvesting energy from the received signal. The control signal may be filtered, the at least one component may be modified, and the RF signal may be transmitted based on the harvested energy. The apparatus 802/802′ may further include means to configure a master-slave configuration with at least a third module. The first module may be a master module and the at least one third module may be a slave module. The apparatus 802/802′ may further include means to send the control signal to the slave module. The apparatus 802/802′ may further include means to provide power to the slave module. The aforementioned means may be the TX processor 216, transmitter 218, a WLAN controller/short-range communication controller/a WWAN controller, one or more of the aforementioned components of the apparatus 802 and/or the processing system 914 of the apparatus 802′ configured to perform the functions recited by the aforementioned means.

The disclosure may be configured to reduce the number of pins required in the control chip when adding controlled passive elements (e.g., master module, slave module) by utilizing single wire control with communication protocol. In some instances, using the single wire control, as disclosed in the disclosure, may eliminate the need for control pins. The ability to add controlled passive elements is not constrained by the availability of control pins on the control chip. At least one advantage of the disclosure is that control wires from the control chip to the controlled passive elements are not necessary. Running control wires may be burdensome of difficult, especially in instances where the distance between the control chip and controlled passive elements is great or inaccessible. At least another advantage of the disclosure is that since a connection to a control pin is not required, controlled passive elements may be easily added on to existing products. Additionally, control and/or features of controlled passive elements may be added and/or updated with software updates.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of operation of a first module of a first apparatus, comprising:
receiving, from a power amplifier of a second module of a second apparatus, a signal including a radio frequency (RF) signal for transmission by the first module and a control signal modulated with the RF signal;
filtering the control signal from the RF signal within the received signal;
modifying at least one component within the first module based on the filtered control signal; and
transmitting the RF signal from the first module, the transmission of the RF signal being based on the at least one component modified based on the received control signal.

2. The method of claim 1, further comprising harvesting energy from the received signal, wherein the control signal is filtered, the at least one component is modified, and the RF signal is transmitted based on the harvested energy.

3. The method of claim 1, wherein the first apparatus is on a first printed circuit board (PCB) and the second apparatus is on a second printed circuit board (PCB).

4. The method of claim 3, wherein the first PCB and the second PCB are different.

5. The method of claim 3, wherein the first PCB and the second PCB are a same PCB.

6. The method of claim 1, wherein the first module comprises a filter circuit configured to receive the RF signal and filter the control signal from the RF signal.

7. The method of claim 1, wherein the first module comprises a control circuit configured to receive the control signal, and to modify the at least one component based on the control signal.

8. The method of claim 1, further comprising at least one third module connected to the first module in a master-slave configuration, wherein the first module is a master module and the at least one third module is a slave module, and wherein the at least one third module transmits the RF signal.

9. The method of claim 8, wherein the master module is configured to send the control signal to the slave module.

10. The method of claim 8, wherein the first module is configured to provide power to the slave module.

11. The method of claim 8, wherein each of the at least one third module is configured to communicate with any of the at least one third module.

12. An apparatus for wireless communication, comprising:
means for receiving, from a power amplifier of a second module of a second apparatus, a signal including a radio frequency (RF) signal for transmission by a first module of a first apparats and a control signal modulated with the RF signal;
means for filtering the control signal from the RF signal within the received signal;
means for modifying at least one component within the first module based on the filtered control signal; and
means for transmitting the RF signal from the first module, the transmission of the RF signal being based on the at least one component modified based on the received control signal.

13. The apparatus of claim 12, further comprising means for harvesting energy from the received signal, wherein the control signal is filtered, the at least one component is modified, and the RF signal is transmitted based on the harvested energy.

14. The apparatus of claim 12, wherein the first apparatus is on a first PCB and the second apparatus is on a second PCB.

15. The apparatus of claim 14, wherein the first PCB and the second PCB are different.

16. The apparatus of claim 14, wherein the first PCB and the second PCB are a same PCB.

17. The apparatus of claim 14, wherein the first module comprises a filter circuit configured to receive the RF signal and filter the control signal from the RF signal.

18. The apparatus of claim 14, wherein the first module comprises a control circuit configured to receive the control signal, and to modify the at least one component based on the control signal.

19. The apparatus of claim 14, further comprising at least one third module connected to the first module in a master-slave configuration, wherein the first module is a master module and the at least one third module is a slave module, and wherein the at least one third module transmits the RF signal.

20. The apparatus of claim 19, wherein the master module is configured to send the control signal to the slave module.

21. The apparatus of claim 19, wherein the first module is configured to provide power to the slave module.

22. The apparatus of claim 19, wherein each of the at least one third module is configured to communicate with any of the at least one third module.

23. An apparatus for wireless communication, comprising:
a memory; and
at least one processor coupled to the memory and configured to:
receive, from a power amplifier of a second module of a second apparatus, a signal including a radio frequency (RF) signal for transmission by a first module of a first apparatus and a control signal modulated with the RF signal;
filter the control signal from the RF signal within the received signal;
modify at least one component within the first module based on the filtered control signal; and
transmit the RF signal from the first module, the transmission of the RF signal being based on the at least one component modified based on the received control signal.

24. The apparatus of claim 23, further comprising harvesting energy from the received signal, wherein the control signal is filtered, the at least one component is modified, and the RF signal is transmitted based on the harvested energy.

25. The apparatus of claim 23, wherein the first apparatus is on a first PCB and the second apparatus is on a second PCB.

26. The apparatus of claim 25, wherein the first PCB and the second PCB are different.

27. The apparatus of claim 25, wherein the first PCB and the second PCB are a same PCB.

28. The apparatus of claim 23, wherein the first module comprises a filter circuit configured to receive the RF signal and filter the control signal from the RF signal.

29. The apparatus of claim 23, wherein the first module comprises a control circuit configured to receive the control signal, and to modify the at least one component based on the control signal.

30. The apparatus of claim 23, further comprising at least one third module connected to the first module in a master-slave configuration, wherein the first module is a master module and the at least one third module is a slave module, and wherein the at least one third module transmits the RF signal.

31. The apparatus of claim 30, wherein the master module is configured to send the control signal to the slave module.

32. The apparatus of claim 30, wherein the first module is configured to provide power to the slave module.

33. The apparatus of claim 30, wherein each of the at least one third module is configured to communicate with any of the at least one third module.

34. A non-transitory computer-readable medium storing computer executable code, comprising code to:
receive, from a power amplifier of a second module of a second apparatus, a signal including a radio frequency (RF) signal for transmission by a first module of a first apparatus and a control signal modulated with the RF signal;
filter the control signal from the RF signal within the received signal;
modify at least one component within the first module based on the filtered control signal; and
transmit the RF signal from the first module, the transmission of the RF signal being based on the at least one component modified based on the received control signal.
